(19) United States
(12) Patent Application Publication
(10) Pub. No.: US 2009/0235773 A1
(43) Pub. Date: Sep. 24, 2009

(54) CASING SYSTEM FOR PROTECTING A CABLE

(76) Inventor: Yuan-Hung Wen, Taichung City (TW)

Correspondence Address: Chien-Hui Su, P. O. Box 70-121 Taichung, Taichung City, 40899, TW

(21) Appl. No.: 12/050,953

(22) Filed: Mar. 19, 2008

(51) Int. Cl. F16C 1/10

(52) U.S. Cl. 74/502.4

(57) ABSTRACT

The casing system for protecting a cable, the casing having a first end and a second end; a recess positioning inside of the first end, an inner diameter of the recess being equal to or greater than a outer diameter of the second end, a groove positioning in the recess, a passageway penetrating through the groove to the second end of the casing for communicating the first end and the second end; at least two rolling portions installing in the recess, a distance between the rolling portions being less than an inner diameter of the passageway; wherein, the rolling portions grip the cable that provides protective effect for a cable.

### FIELD OF THE INVENTION

The present invention relates to a casing system, particularly to a casing with at least two rolling portions inside for gripping the cable and omitting the plastic tube around the cable.

### BACKGROUND OF THE INVENTION

For riding bicycle, brake cable is very important; in the past, brake cable are exposed outside of the bicycle that be drenched and shined every day, even the steel brake cable also gets rusty, so the manufacturer usually using a flexible plastic tube covering around the cable for attaining protective effect, and flexible plastic tube can be bent different radian for satisfying the bicycle.

However, the plastic tube will lose the bounce to be brittle and easily peel off for a long time using, that moment, the plastic tube will be broken and fail to protect the brake cable anymore, especially when the brake cable be bent with different radian, the cable will be exposed out of the plastic tube, that dust will influence the acting of the brake cable; moreover, it is fixed when the plastic tube is cut for covering around the brake cable, and the plastic tube can't make any adjustment if the length of the brake cable is need to be adjusted.

U.S. Pat. No. 6,250,175 provides an improvement that includes a cable for transmitting a tensile force, a flexible tube for accommodating the cable, and a casing surrounding the tube for absorbing a pressure force. The casing is composed of a plurality of form-parts so joined to one another as to form a continuous axial passageway which is defined by an inside dimension. The form-parts are so configured that abutting end faces between successive form-parts have a complementary configuration to thereby enable a disposition of the casing along an arcuate path, with the tube being defined by an outside dimension corresponding to the inside dimension of the passageway.

But, the outer of the cable of those prior arts still covers the flex tube for avoiding the cable contacting with the casing that influences the acting of the cable, the flexible tube will be brittle and peel off inside of the casing, that the peel of flexible tube will stuck the casing and blocking the pull movement of the cable. Furthermore the flexible tube is usually made with plastic in addition to cover the cable, it's cost a lot for manufacturing. And the prior art just has different caliber of two end of the casing for joining to one another, it is very easy to loose and it couldn't provide stably connecting effect for joining one to each other. Thus there is an eager demand for a novel design which can improve the defect in the prior art.

### SUMMARY OF THE INVENTION

Accordingly, the primary object of the present invention is to provide better structure for connecting and wider angle for bending, and the present invention can avoid the plastic tube covering around the cable.

To achieve the above objectives, the present invention provides a casing system for protecting a cable, the casing having a first end and a second end; a recess positioning inside of the first end, an inner diameter of the recess being equal to or greater than a outer diameter of the second end, a groove positioning in the recess, a passageway penetrating through the groove to the second end of the casing for communicating the first end and the second end; at least two rolling portions installing in the recess, a distance between the rolling portions being less than an inner diameter of the passageway; and wherein, the second end of the casing assembles into the recess of the first end of another casing for joining plurality of the casing to form a continuous casing system for admitting a cable, the cable admitted in between the rolling portions for gripping the cable and protecting the cable.

The outer surface of the second end of the present invention is in a shape of convex curve, when the second end of the casing plugs into the recess of the first end of another casing, the second end of the casing has a wider angle for pivoting that corresponding to the cable. Otherwise, the second end of the casing has less pivoting limitation because of the outer diameter of the annular portion is less than the outer surface of the second end and the inner diameter of the recess of the first end. The annular portion can slightly lock the first end for providing a stronger and more stable structure of the casing system. The rolling portion grips the cable for avoiding the cable contacting the casing, it don't need to cover a flexible plastic tube around the cable additionally, the cable still can work for transmitting a tensile force as usual, the casing of the present invention can protect the cable well. Moreover, the rolling portion can be a roller or a ball cooperating with a spring for gripping the cable tightly.

The various objectives and advantages of the present invention will be more readily understood from the following detailed description when read in conjunction with the appended drawing.

### BRIEF DESCRIPTION OF THE DRAWINGS

FIG. 1 is a cutaway view of the first embodiment of the present invention.

FIG. 2 is a cutaway, assembling view of the first embodiment of the present invention.

FIG. 3 shows the operation and cross-sectional view of the first embodiment of the present invention.

FIG. 4 is a operation and sectional perspective view of the first embodiment of the present invention.

FIG. 5 is a cutaway view of the second embodiment of the present invention.

FIG. 6 is a perspective view of the third embodiment of the present invention.

FIG. 6 is a perspective view of the forth embodiment of the present invention.

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

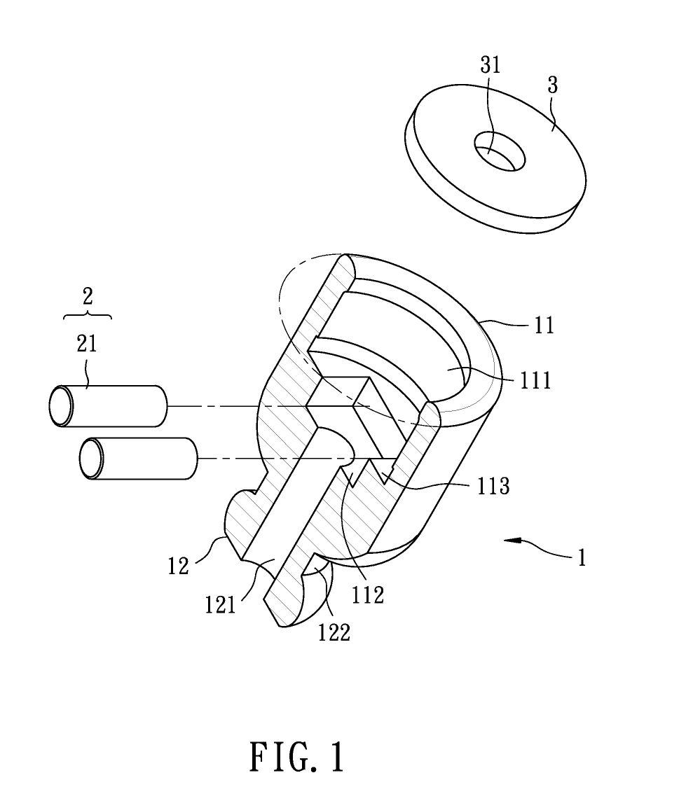

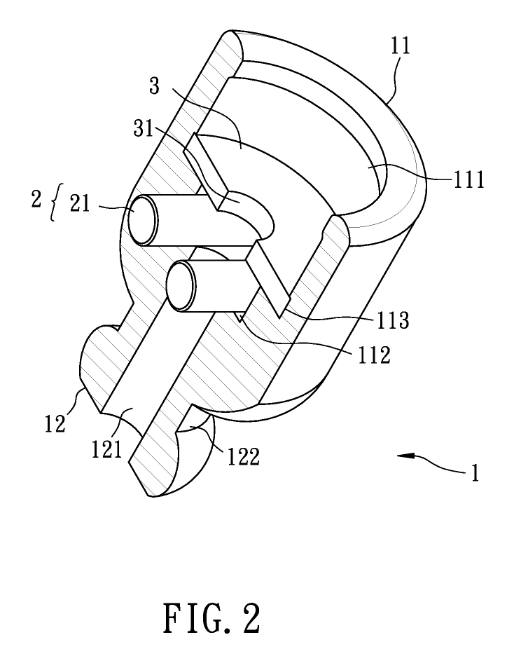

Referring the first embodiment of FIG. 1 to FIG. 4, a casing 1 system for protecting cable 4 according to the present invention is illustrated.

The casing 1 of the present invention has the following elements:

two end of the casing 1 are defined a first end 11 and a second end 12, an outer diameter of the first end 11 is greater than an outer diameter of the second end 12. An outer surface of the second of the casing 1 is in a shape of convex curve. An annular portion 122 is positioned between the first end 11 and the second end 12, an outer diameter of the annular portion 122 is less than an inner diameter of the recess 111 of the first end 11 and the outer diameter of the second end 12. A recess 111 axial positions inside the first end 11, an inner diameter of the recess 111 is equal to or greater than an outer diameter of the second end 12, so the second end 12 of the casing 1 can plug into the recess 111 of the first end 11 of another casing 1. A groove 112 axial positions in the bottom of the recess 111 to be formed of a quadrate shape, a dimension of the bottom of the groove 112 is less than a dimension of the bottom of the recess 111. Two rolling portions 2 of the first embodiment are rollers 21 installing in the recess 111. A passageway 121 axial penetrates through the bottom of the groove 112 to the second end 12 for communicating the first end 11 and the second end 12, an inner diameter of the passageway 121 is less than the inner diameter of the recess 111, a distance between the two rollers 21 is less than the inner diameter of the passageway 121. A rut 113 positions nearby the groove 112 of the recess 111 for installing a circular washer, the washer covers the groove 112 for avoiding the rollers 21 falling from the groove 112. A passing hole penetrates through to the center of the washer;

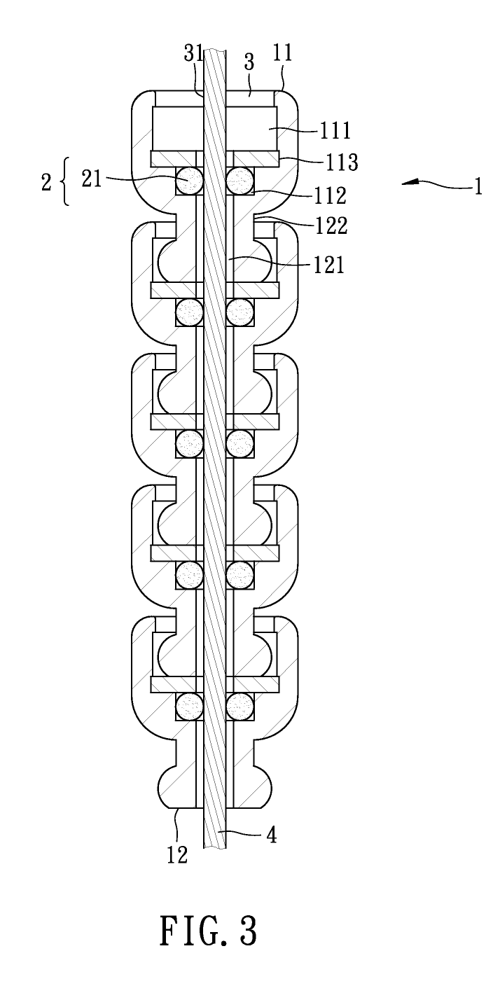

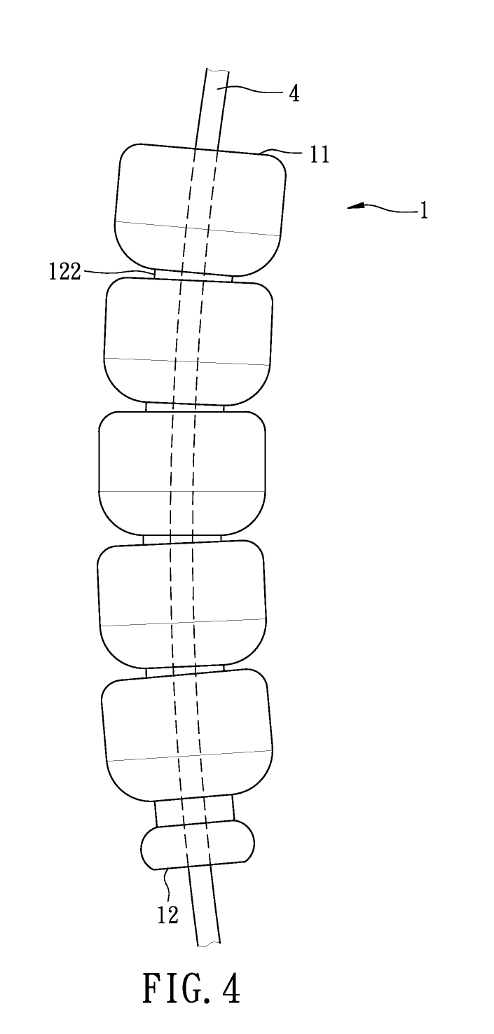

as FIG. 3 and FIG. 4 shows, the recess 111 of the first end 11 communicates the groove 112. The passageway 121 of the second end 12, the diameter of the recess 111 of the first end 11 is equal to or greater than the outer diameter of the second end 12 for plugging the second end 12 of the casing 1 into the recess 111 of the first end 11 of another casing 1, so the plurality of the casing 1 are formed of a continuous casing 1 system for assembling into a cable 4; a length of the continuous casing 1 system is corresponding to a length of the cable 4. Because of the outer surface of the second end 12 is in a shape of convex curve, when the second end 12 of the casing 1 plugs into the recess 111 of the first end 11 of another casing 1, the second end 12 of the casing 1 has a wider angle for pivoting that corresponding to cable 4. Otherwise, the second end 12 of the casing 1 has less pivoting limitation because of the outer diameter of the annular portion 122 is less than the outer surface of the second end 12 and the inner diameter of the recess 111 of the first end 11; and

the distance between the two rollers 21 is less than the inner diameter of the passageway 121, so the two rollers 21 can grip the cable 4 for avoiding the cable 4 contacts the casing 1. Furthermore the rollers 21 also provide rolling effect that cable 4 can transmit a pulling force as usual, in that, it don't need to cover a flexible plastic casing 1 around the cable 4 additionally, the casing 1 of invention can protect the cable 4 well.

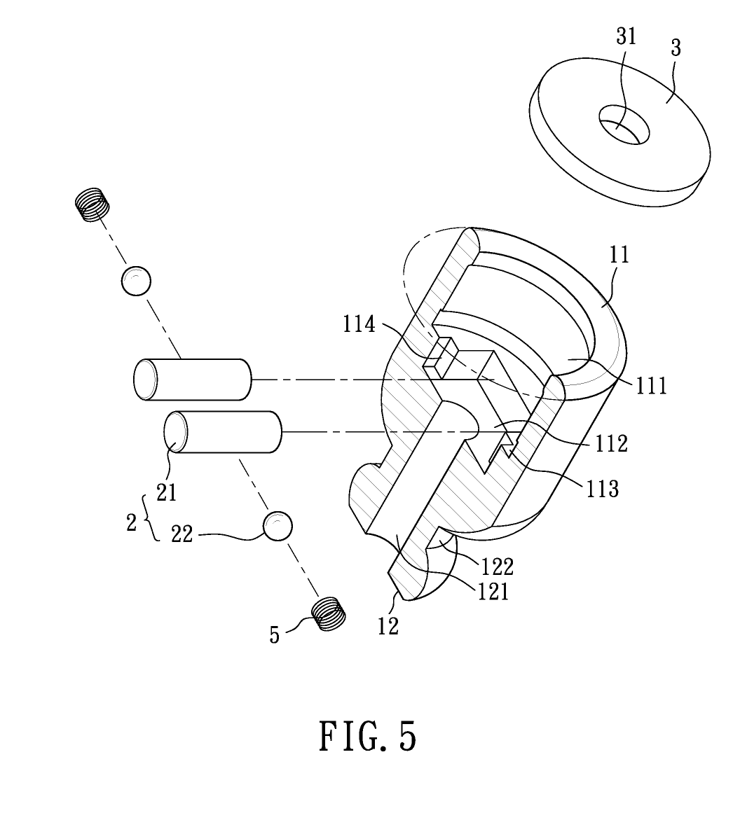

FIG. 5 shows the second embodiment, a socket 114 is positioned in the both side of the groove 112 for installing a spring 5 and a ball 22 respectively, the spring 5 pushes the ball 22 and the roller 21 so that the two rollers 21 get more power for gripping the cable 4. A contact surface of the ball 22 and the roller 21 is smooth that the cable 4 can smooth transmitting a tensile force.

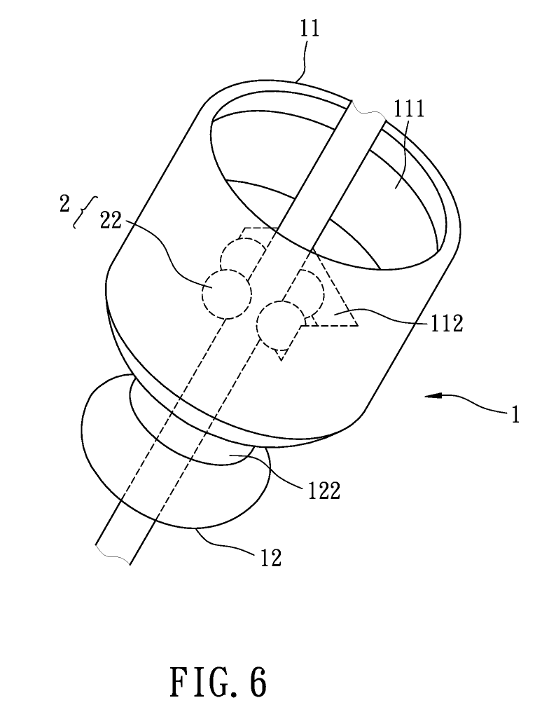

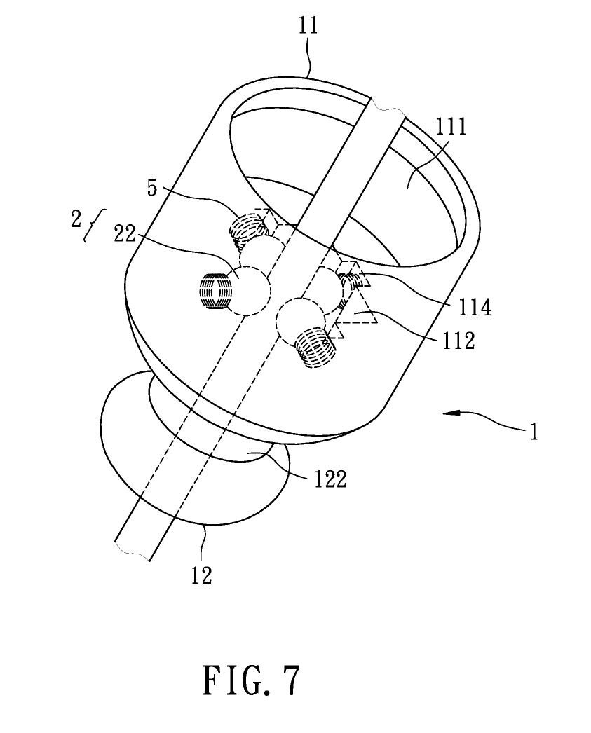

FIG. 6 shows the third embodiment, the two rolling portions 2 can substitute for the four balls 22, the four balls 22 install in the groove 112 and the washer covers the groove 112 for positioning the balls 22, a distance between the four balls 22 is less than the inner diameter of the passageway 121. Thus the four balls 22 can grip the cable 4 for avoiding the cable 4 contacts the casing 1, and cable 4 can transmit a pulling force as usual so that the casing 1 of invention can protect the cable 4 well.

FIG. 7 shows the forth embodiment, each socket 114 is positioned in four sides of the quadrate groove 112 for installing a spring 5 respectively, so the spring 5 can push the ball 22 for getting more power for gripping the cable 4 tightly.

However, above mentioned embodiments are just examples of the present invention, they are not confined the scope of the present invention. The forms of the handle and head and the location of the slot may be varied as desired.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

1: A casing system for protecting a cable, said casing having a first end and a second end comprising:
a recess positioning inside the first end, an inner diameter of the recess being equal to or greater than an outer diameter of the second end, a groove positioning in the recess, a passageway penetrating through the groove and the second end of the casing for communicating the first end and the second end;
at least two rolling portions installing in the groove, a distance between the rolling portions being less than an inner diameter of the passageway, the rolling portions providing rolling effect such that the cable transmits a pulling force;
a washer installed nearby the groove of the recess and covering the groove for avoiding the rolling portions falling from the groove;
a rut positioned nearby the groove for installing the washer; and
wherein the second end of the casing assembles into the recess of the first end of another casing for joining a plurality of the casings to form a continuous casing system for admitting the cable, the cable admitted in between the rolling portions for gripping the cable and protecting the cable.

2: The casing system for protecting a cable as claimed in claim 1, wherein a passing hole penetrates through the washer.

3. (canceled)

4: The casing system for protecting a cable as claimed in claim 1, wherein the rolling portion is a roller or a ball.

5: The casing system for protecting a cable as claimed in claim 1, wherein at least two springs are installed in the groove for pushing the rolling portion.

6: The casing system for protecting a cable as claimed in claim 1, wherein an annular portion is positioned in between the first end and the second end of the casing, an outer diameter of the annular portion is less than the outer diameter of the second end.

7: The casing system for protecting a cable as claimed in claim 1, wherein an outer surface of the second end of the casing is in a shape of convex curve.
